(19) United States
(12) Patent Application Publication
(10) Pub. No.: US 2026/0236683 A1
(43) Pub. Date: Aug. 13, 2026

(54) QUANTUM MACHINE LEARNING POWERED INNOVATIONS FOR NOISE REDUCTION IN SENTIMENT ANALYSIS

(71) Applicant: WELLS FARGO BANK, N.A., San Francisco, CA (US)

(72) Inventors: Ravi Kumar Gokanakonda, Guntur (IN); Anushka Rajesh Karambelkar, Satara (IN); Jyothikamalesh Sabapathi, Coimbatore (IN); Karuna Narayan Kadam, Pune (IN); Prital Ganapati Patil, Pune (IN); Tarun Rama Vaibhav Cheruvu, Guntur (IN)

(21) Appl. No.: 19/048,789

(22) Filed: Feb. 7, 2025

(51) Int. Cl. G06F 40/30; G06N 10/20; G06N 10/60; G06N 20/00

(52) U.S. Cl. CPC G06F 40/30; G06N 10/20; G06N 10/60; G06N 20/00

(57) ABSTRACT

Systems and methods for performing sentiment analysis using natural language processing techniques are provided. A method includes: receiving an input dataset comprising a plurality of natural language sentences and a plurality of sentiment labels; pre-processing the input dataset to convert each natural language sentence into a string diagram representation; converting each string diagram into embedded representations; determining, using a hybrid deep learning model, a predicted sentiment label associated with each embedded representation, wherein each predicted sentiment label is associated with a respective probability that each natural language sentence belongs to a first class; identifying for each predicted sentiment label, a noise level; and optimizing a performance of the hybrid deep learning model by updating one or more parameters of the hybrid deep learning model.

### TECHNICAL FIELD

The present disclosure generally relates to natural language processing (“NLP”), and more particularly to quantum machine learning (“ML”) powered innovations for noise reduction in sentiment analysis.

### BACKGROUND

NLP techniques employing ML models are a core component in natural language understanding (“NLU”). ML models are trained on vast datasets to draw inferences on human-like text. One type of ML task in the field of NLU involves classification problems. Such classification tasks involve predicting categorical labels for given inputs where the output is a discrete value representing a class or category. One type of classification task involves analyzing an input dataset of natural language sentences and performing sentiment analysis on the sentences to predict whether each natural language sentence is a positive sentiment natural language sentence or negative sentiment natural language sentence. Given the complexity involved with human text and speech, ML models can struggle to correctly identify underlying semantic patterns and relationships between the words in the natural language sentences. As a result, the ML model performing sentiment analysis may predict that a natural language sentence(s) having a true negative sentiment as incorrectly belonging to the positive sentiment label class. Despite the progress made in field of NLU as it relates to classification problems, there is a need in the art for improved techniques for noise reduction in sentiment analysis.

### SUMMARY

Certain aspects and features of the present disclosure generally relate to natural language processing, and more particularly to quantum ML powered innovations for noise reduction in sentiment analysis. According to an aspect of the present disclosure, a method of training a hybrid deep learning model for sentiment analysis includes: receiving an input dataset comprising a plurality of natural language sentences and a plurality of sentiment labels, wherein each natural language sentence is associated with a respective sentiment label; pre-processing the input dataset to convert each natural language sentence into a string diagram representation to thereby generate a plurality of string diagrams; converting each of the plurality of string diagrams into a plurality of embedded representations usable for processing by a hybrid deep learning model; determining, using the hybrid deep learning model, a predicted sentiment label associated with each embedded representation to thereby generate a plurality predicted sentiment labels, wherein each predicted sentiment label is associated with a respective probability that each natural language sentence belongs to a first class; identifying for each predicted sentiment label, a noise level; and optimizing a performance of the hybrid deep learning model by updating one or more parameters of the hybrid deep learning model.

In some examples, the plurality of embedded representations comprises a plurality of tensor representations and wherein the hybrid deep learning model is implemented by classical computational circuitry. In some examples, the plurality of embedded representations comprises a plurality of tensor ansatz representations, where the hybrid deep learning model is implemented by quantum computing circuity. In these examples, the method further comprises mapping the plurality of tensor ansatz representations to a plurality of quantum circuits for use by the quantum computing circuitry.

In some examples, the hybrid deep learning model comprises one or more quantum machine learning algorithms implemented by quantum computing circuitry. In some examples, identifying the noise level comprises evaluating each respective probability using a binary cross entropy loss function, and wherein optimizing the hybrid deep learning model comprises minimizing the binary cross entropy loss function. In some examples, prior to receiving the input dataset, the hybrid deep learning model is generated by fine-tuning a first instance of a pre-trained deep learning model.

In some examples, optimizing the performance of the hybrid deep learning model further comprises generating, based on updating the one or more parameters, a second instance of the hybrid deep learning model, wherein the one or more parameters are associated with one or more weights of the hybrid deep learning model; and fine-tuning the second instance of the hybrid deep learning model.

In some examples, the plurality of sentiment labels comprises a first sentiment label associated with a positive class and a second sentiment label associated with a negative class. In some examples, the method further comprises performing a dimensional reduction technique on each of the plurality of string diagrams based on one or more redundant semantic features associated with each of the plurality of string diagrams.

In some examples, the method further comprises receiving, after updating one or more parameters of the hybrid deep learning model, a second input dataset, wherein the second input dataset comprises a plurality of unlabeled customer reviews; and performing sentiment analysis on the second input dataset using the hybrid deep learning model including updates to the one or more parameters.

The above methods may be implemented in a cloud service executed on cloud service provider infrastructure, which may include various servers, processors, and databases. The above methods can also be implemented as computer-executable program instructions stored in a non-transitory, tangible computer-readable medium or media and/or operating within a system including one or more processors or other processing device and memory.

An additional example includes a system including one or more processors. The system also includes a memory coupled to the one or more processors. The memory includes instructions that when executed by the one or more processors, causes the one or more processors to: receive an input dataset comprising a plurality of natural language sentences and a plurality of sentiment labels, wherein each natural language sentence is associated with a respective sentiment label; pre-process the input dataset to convert each natural language sentence into a string diagram representation to thereby generate a plurality of string diagrams; convert each of the plurality of string diagrams into a plurality of embedded representations usable for processing by a hybrid deep learning model; determine, using the hybrid deep learning model, a predicted sentiment label associated with each embedded representation to thereby generate a plurality predicted sentiment labels, wherein each predicted sentiment label is associated with a respective probability that each natural language sentence belongs to a first class; identify for each predicted sentiment label, a noise level; and optimize a performance of the hybrid deep learning model by updating one or more parameters of the hybrid deep learning model.

Yet another example includes a non-transitory computer-readable medium embodying program code that is executable by one or more processors to cause the one or more processors to: receive an input dataset comprising a plurality of natural language sentences and a plurality of sentiment labels, wherein each natural language sentence is associated with a respective sentiment label; pre-process the input dataset to convert each natural language sentence into a string diagram representation to thereby generate a plurality of string diagrams; convert each of the plurality of string diagrams into a plurality of embedded representations usable for processing by a hybrid deep learning model; determine, using the hybrid deep learning model, a predicted sentiment label associated with each embedded representation to thereby generate a plurality predicted sentiment labels, wherein each predicted sentiment label is associated with a respective probability that each natural language sentence belongs to a first class; identify for each predicted sentiment label, a noise level; and optimize a performance of the hybrid deep learning model by updating one or more parameters of the hybrid deep learning model.

This summary is not intended to identify the key or essential features of the claimed subject matter, nor is it intended to be used in isolation to determine the scope of the claimed subject matter. Rather, the summary is merely a simplified and non-limiting summary of the innovation that is intended to provide a basic understanding of some aspects of the innovation. The subject matter should be understood by reference to appropriate portions of the entire specification of this disclosure, any or all drawings, and each claim.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Various non-limiting embodiments are further described with reference to the accompanying drawings, in which:

FIG. 1 is an example computing environment for sentiment analysis, according to one or more aspects of the present disclosure;

FIG. 2 is a block diagram illustrating a sentiment analysis platform, according to one or more aspects of the present disclosure;

FIG. 3 is a block diagram illustrating an example analysis pipeline of the sentiment analysis platform of FIG. 2, according to one or more aspects of the present disclosure;

FIG. 4 is a block diagram illustrating an example data flow for implementing a hybrid deep learning model for sentiment analysis, according to one or more aspects of the present disclosure;

FIG. 5 is a flowchart of an example of a process for training a hybrid deep learning model for sentiment analysis, according to one or more aspects of the present disclosure;

FIG. 6 is a block diagram illustrating an example computer-readable medium or computer-readable device including processor-executable instructions configured to embody one or more aspects of the present disclosure; and

FIG. 7 and the following discussion provide a description of a suitable computing environment to implement embodiments of one or more aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

There is a growing need for innovative tools and techniques that can accurately identify customer sentiment dynamics. Customer sentiment dynamics have immense value in the enterprise context in terms of predictive analytics and proactive customer engagement. To maintain and enhance customer relationships, enterprises seek solutions that can provide nuanced insights into customer sentiments, enabling them to offer tailored services and anticipate evolving needs. In addition, customer sentiment dynamics, which often take the form of customer reviews, surveys, news reports, social media posts, and the like, are often written by customers in the form of natural language (e.g., English, Spanish, etc.) sentences. Such natural language sentences associated with human speech are inherently complex.

An aspect of the present disclosure provides for a sentiment analysis platform that leverages the capabilities of classical and quantum ML techniques (e.g., a “hybrid deep learning model”) to perform sentiment analysis on customer reviews, surveys, news reports, social media posts, and the like (herein referred to as “input data” or “input datasets”). The use of a hybrid deep learning model employing both classical and quantum ML models enables enhanced pattern recognition in the semantics involved in the natural language sentences of the input data. For instance, the use of quantum ML techniques enable more effective modeling of the complexities inherent in natural language speech through leveraging quantum principles such as quantum superposition and entanglement. The linguistic structures of the input data therefore are able to be represented in higher dimensional spaces making it easier to capture the intricate relationships between the words and phrases thereby improving the understanding of sentiment in the text. These techniques can improve upon classical ML mechanisms which rely heavily on statistical patterns and predefined rules that can miss the deeper meaning in specific contexts.

One example of the present disclosure involves training a hybrid deep learning model to perform sentiment analysis. Training the hybrid deep learning model involves receive an input dataset comprising natural language sentences. The input dataset, in the case of model training, can also include predefined sentiment labels. The input dataset may be pre-processed using a variety of pre-processing techniques such as cleaning the input dataset, tokenization of the input dataset, rewriting (e.g., removing redundancies or irrelevant terms) in the input dataset, and embedding of the input dataset. The pre-processed input dataset is then used to train classification algorithms such as logistic regression algorithms, support vector machines, named based decision trees, random forest gradient boosting algorithms, etc., implemented by the hybrid deep learning model(s). The accuracy of the models in performing sentiment analysis may be measured using various metrics such as accuracy, precision, area under the curve (“AUC”), receiver operating characteristics (ROC), etc.

Examples of the present disclosure also provide for optimization techniques to fine-tune the hybrid deep learning model(s). For instance, and according to one particular example, optimization the ML algorithms implemented by the hybrid deep learning model may be performed through implementation of a loss function. In this example, a binary cross entropy loss function may be utilized to identify a noise level in the predicted sentiments. The binary cross entropy loss function quantifies a difference between the true sentiment labels of the input data and the predicted probabilities generated by the hybrid deep learning model. Based on the identified noise levels, one or more parameters (e.g., weights) of the hybrid deep learning model may be adjusted to minimize the noise levels thereby improving the accuracy of the predicted sentiment labels. In this example, updating the weights of the hybrid deep learning model may be performed using gradient descent where, during each training iteration, backpropagation is used to compute the gradients of the loss function with respect to the hybrid deep learning model parameters indicating a direction and magnitude of changes needed to minimize the loss. The ML models'parameters are then updated accordingly. After model optimization and fine-tuning of the hybrid deep learning model, the hybrid deep learning model, during the inference phase, may predict sentiment labels on the inference dataset. These predicted sentiment labels may then be used by the enterprise to better understand their customers'feedback and areas where the enterprise needs to improve its capabilities.

While certain embodiments are described, these embodiments are presented by way of example only and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. Further details regarding the systems and methods are provided below in relation to the drawings.

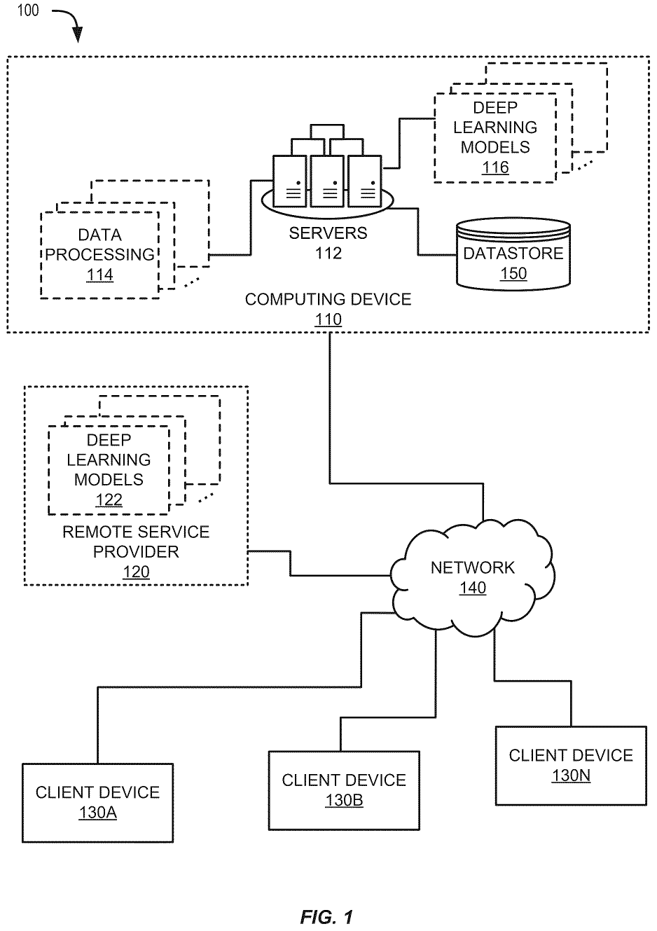

Referring now to FIG. 1, FIG. 1 is an example computing environment 100 for sentiment analysis, according to one or more aspects of the present disclosure. In the example computing environment 100, a computing device 110 and a number of client devices 130A-130N (which may be referred to herein individually as a client device 130 or collectively as the client devices 130) are connected via a network 140. Network 140 can be the internet or any suitable communications network or combination of communications network may be employed, including LANs (e.g., within a corporate private LAN), WANs, MANs, cellular network (e.g., 3G, 4G, 4G LTE, 5G, etc.), or any combination of these.

The client devices 130A-130N can be any suitable computing or communications device. For example, client devices 130A-130N may be desktop computers, laptop computers, tablets, smart phones having processors and computer-readable media, connected to the computing device 110 using the internet, via a smartphone or desktop application, or other suitable computer network. The client devices 130A-130N have communication software installed to enable them to transmit data to the computing device 110. For instance, such communication software enables the client devices 130A-130N to access a web application, an account associated with a user of one of the client devices 130A-130N, and so on. As part of the data transmission, and according to one particular example, the client devices 130A-130N may transmit text data in the form of customer sentiment dynamics, which often take the form of customer reviews, surveys, news reports, social media posts (e.g., customer feedback from an experience the computer had with the computing device 110).

According to one particular example, client device 130A may be associated with a computing device of a user. The user may maintain an account with an enterprise. The enterprise may operate a variety of servers (not shown) hosting a web application where the user may access their account within the web application and perform various actions within their account associated with their finances (e.g., deposit funds, transfer funds, pay bills, allocate funds for investments, and so on). During the user interaction via client device 130A across network 140 with the web application, the user may experience technical difficulties and/or may be unable to perform their desired task and as a result, may exit the web application. Shortly after the experience, the user may be contacted by the enterprise hosting the web application requesting feedback from the user regarding their experience with the web application. The request from the enterprise may provide the user with a window where a user can type their feedback. This feedback, in the form of text data comprising natural language sentences in the language of the user (e.g., English, Spanish, etc.) may then be transmitted over network 140 to computing device 110 where computing device 110 may perform sentiment analysis on the feedback.

More specifically, computing device 110 operates a number of servers 112 that can provide sentiment analysis functionality on the received data from the various client devices 130A-130N. As shown in FIG. 1, sentiment analysis is provided by one or more instances of data processing 114 and deep learning models 116 that can be executed and allocated to or used by the computing device 110 to perform sentiment analysis on the various data transmission elements received from client devices 130A-130N. Also included in computing device 110 is datastore 150. Datastore 150 may be a part of computing device 110 or datastore 150 may be a remotely accessible datastore such as a cloud data storage location the is accessible by computing device 110 via a network, such as network 140.

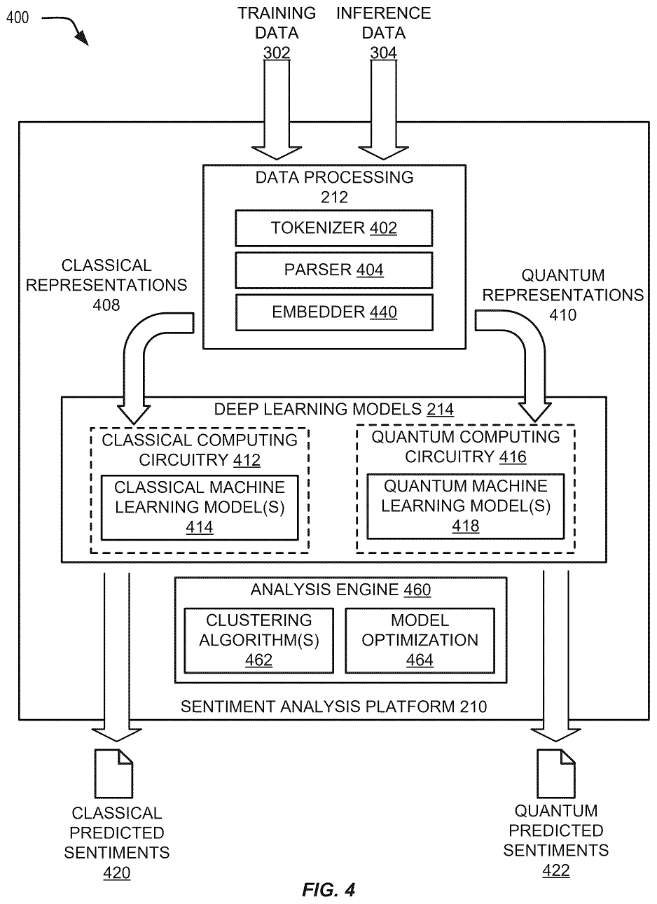

Datastore 150 may store a variety of data usable by the one or more instances of data processing 114 and deep learning models 116 to implement the techniques described herein. For example, and with respect to the user feedback example described above, datastore 150 may store a plurality of user reviews received from client devices 130A-130N. In other words, each client device of client devices 130A-130N may be associated with a particular user who has provided a review, feedback, or information to an enterprise. Each of these reviews, feedback, or information may be received over network 140 by computing device 110 and stored in datastore 150 for processing. As referred to herein, the collective group of all user reviews, feedback, and information provided by users on client devices 130A-130N may collectively be referred to as an “inference dataset.” The inference dataset may refer to unlabeled user data that an enterprise wishes to perform sentiment analysis on to determine a sentiment of each element (e.g., a positive sentiment label, a negative sentiment label, a neutral sentiment label, and so on). The enterprise may evaluate the inference dataset to identify areas within the enterprise where users are experiencing frustrations, technical issues, etc. that require remediation. Datastore 150 may also store training data in the form of user reviews, feedback, survey responses, etc. (herein referred to collectively at “training dataset”). The training dataset stored in dataset 150 may also include predefined sentiment labels (e.g., positive, negative, neutral, etc.). The training dataset may be used to train one or more deep learning models, such as deep learning model 116, to perform sentiment analysis on the inference dataset. The training process is described in more detail below, but in genera;, and prior to performing sentiment analysis on the inference dataset, data processing 114 may perform pre-processing operations on the training dataset to prepare the training dataset for processing and training by one or more ML models allocated from deep learning models 116. The pre-processing techniques performed on the training dataset are described in more detail with respect to FIG. 4. Generally, the pre-processing operations include various techniques to tokenize, parse, and convert the training dataset into a form usable by the deep learning models 116 to perform sentiment analysis (e.g., an embedded representation).

Continuing with FIG. 1, and in the case of either a training phase or inference phase, the pre-processing operations performed by data processing 114 may generate an embedded representation of the training and/or inference dataset usable by one or more ML models employed by deep learning models 116. For instance, data processing 114 may first tokenize the input dataset to deconstruct the various natural language sentences into individual tokens where each token represents a single sentence of the various natural language sentences included in the input data. Next, a parser of the data processing 114 may be employed to parse the individual tokens. Parsing the individual tokens may refer to the process of extracting linguistic structures and relationships within the text data. Parsing the tokens enables a deeper understanding of natural language sentence composition.

After parsing, the parsed tokens may be converted into a string diagram format. String diagrams represent the linguistic relationships extracted from the parser in a graphical form that is amenable for both classical and quantum processing. More specifically, the string diagram representations expresses computations in a monoidal category, which is an abstract well-suited to model the functionality of ML models, and in particular quantum ML processes. In a final pre-processing step, the string diagram representations may be transformed into an embedded format. An embedded format may refer to a numerical representation of the string diagram format. For instance, one form of embedded representation which is amenable for quantum ML processes is to convert the string diagrams into a tensor ansatz embedded representation. As another example, the string diagrams may be converted to a tensor representation, which is amenable for classical ML processes. The inventors have determined that deep learning models trained to perform sentiment analysis on natural language sentences perform with higher accuracy when inferring sentiment predictions on embedded representations (e.g., tensor ansatz, tensor diagrams, or otherwise) of string diagrams. Thus, conversion to string diagrams before embedding can outperform conventional classical ML models performing classification tasks on embeddings that did not utilize string diagram representations.

After processing the training dataset using the data processing 114, the output of the data processing 114 may be provided to one or more deep learning models 116 allocated by servers 112. Deep learning models may be trained deep learning models of any suitable type that have been pre-trained for classification and sentiment analysis tasks. In some examples, deep learning models 116 may comprise classical ML models of any suitable type such as Convolutional Neural Networks (“CNNs”), Recurrent Neural Networks (“RNNs”), Long Short-Term Memory Networks (LSTMs), transformer based models (e.g., Dual Intent and Entity Transformer (“DIET”) models, Bidirectional Encoder Representations from Transformers (“BERT”) based models, Generative Pre-trained Transformers (“GPT”), etc.) multilayer perceptions (MLPs), autoencoders, and other suitable neural networks, including future versions of any of these or other classification models. In addition, the deep learning models 116 may comprise quantum ML models of any suitable type such as quantum implementations of any of the above mentioned models as well as additional examples such as Quantum Support Vector Machine (QSVM), Quantum Neural Networks (“QNNs”), Quantum Principal Component Analysis (“QPCA”), Quantum Variational Classifiers (“QVCs”), and so on including future versions of any of these or other quantum ML models usable for classification tasks.

As previously mentioned, and given the inherent complexities associated with human text and speech, deep learning models, such as deep learning model 116, performing a sentiment analysis task may incorrectly predict a sentiment label associated with text data. Such deep learning models may have the propensity for such errors such as misclassifying a text element having a true negative sentiment as having a predicted positive sentiment (i.e., false positives). False positives may occur due to the ambiguities, complexities, and semantic diversity of natural language (e.g., subtle cues, irony, sarcasm, idiomatic expressions) present which can be challenging for deep learning models to accurately interpret. Such nuances require an advanced understanding of language that deep learning models may struggle to achieve. Feature selection and representation of the text data plays an important role in model performance. As described above, one mechanism to improve model performance provided by the present disclosure is to utilize the enhanced semantic understanding provided by the string diagram representations. Additionally, the use of quantum ML models, which are able to process large-scale, high-dimensional data more efficiently by virtual of manipulation of the tensor ansatz representations mapped to quantum circuits (e.g., manipulation of quantum bits (i.e., qubits)) allowing for parallel processing of information, provide another way to improve model performance.

Another way to improve performance of the deep learning models 116 is through model optimization during the training phase. Model optimization involves evaluating the output generated by the deep learning model 116 (i.e., the predicted sentiment label) against the true sentiment label (e.g., the sentiment label included in the training dataset). More specifically, the deep learning model 116 may generate a predicted sentiment label for each natural language sentence, where the predicted sentiment label is associated with a probability value representing the likelihood that the natural language sentence belongs to a particular class (e.g., the positive sentiment class). Then, a loss function may be applied for each predicted probability value. For instance, and according to one particular example, a binary cross entropy loss function may be used, where the binary cross entropy loss function quantifies the difference between the true sentiment labels and the predicted probabilities. Then, during model optimization, the loss function may be minimized by adjusting one or more parameters of the deep learning model 116 (e.g., weights) to improve the predicted probability accuracies. For instance, updating the weights may be performed using gradient descent where during each training iteration, backpropagation is used to compute the gradients of the loss function with respect to the model's parameters indicating a direction and magnitude of changes needed to minimize the loss. The model's parameters are then updated accordingly. After optimizing performance of the deep learning model 116, the deep learning model 116 may be used to predict sentiments on the inference dataset. As mentioned previously, the inference dataset and corresponding predicted sentiments generated by the deep learning model can enable an enterprise to identify areas within the enterprise in need of remediation or improvement. The improved performance of the deep learning models, as described herein and above, such as utilizing string diagram representations, implementing quantum ML models, and so on, can reduce the likelihood of false positives and improve the accuracy in understanding the customer sentiments.

Also included in FIG. 1 is a remote service provider 120. Remote service provider 120 also may include one or more deep learning models, such as deep learning model 122. Similar to the deep learning models 116 included in computing device 110, deep learning models 122 may include ML models of any suitable type such as CNNs, RNNs, LSTMs, DIET modes, BERT model, GPT models, MLPs, autoencoders, QSVMs, QNNs, QPCAs, QVCs, and so on including future versions of any of these or other ML models.

Remote service provider 120 is connected via network 140 to the computing device 110. In some examples, instead of the computing device 110 utilizing one or more servers 112 to allocate processes, such as data processing 114 or deep learning models 116, server 112 may connect to remote service provider 120 via network 140 to access one or more features or functionality provided by remote service provider 120 such as access to one or more deep learning models 122. In these examples, deep learning models 122 need not be incorporated into the computing device 110. Rather, the deep learning models 122 can be a remotely accessible external resource usable by the one or more components of the computing device 110 to facilitate the sentiment analysis.

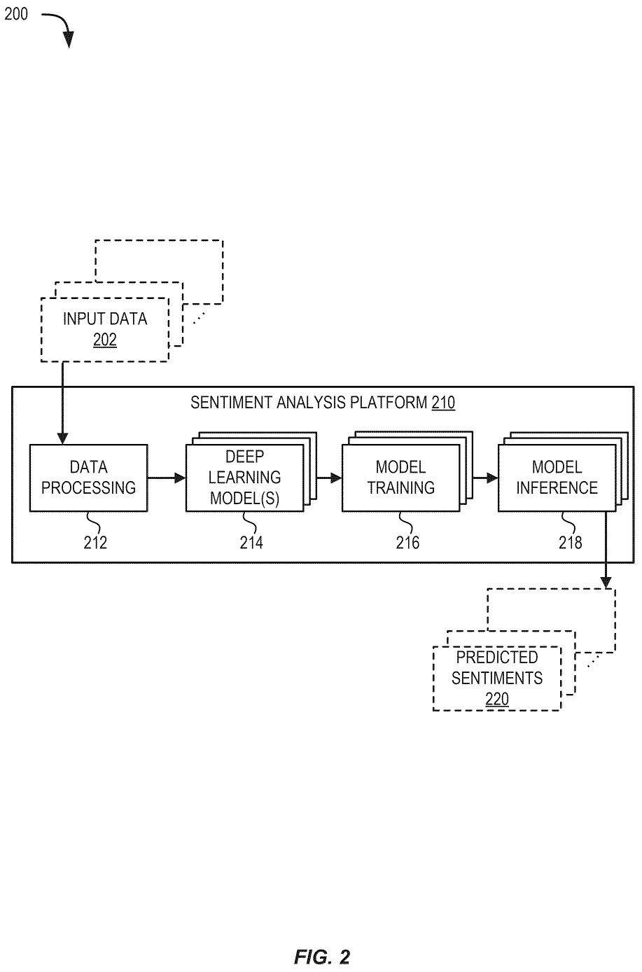

After the deep learning model (e.g., deep learning model 116 or deep learning model 122) is trained and optimized based on training dataset from datastore 150 during the training phase, servers 112 may allocate one or more fine-tuned deep learning models 116 to perform sentiment analysis on the inference dataset. This can include generating predicted sentiment labels for the inference dataset that may be used by an enterprise to identify areas within the enterprise that require remediation or improvement to thereby improve user experience. It will be appreciated that the tasks perform by the computing device 110 described with respect to FIG. 1 and the tasks performed by sentiment analysis platform 210 describe below with respect to FIG. 2, cannot be physically performed in the human mind. Enterprises, in particular large enterprises, may interact with tens of thousands of users, hundreds of thousands users, or even more every single day. Each user may provide feedback on their experience to the enterprise. Thus, the inference dataset may includes hundreds of thousands (or more) entries of user natural language sentence feedback. It would be impracticable (or even impossible) for humans to individual review the inference dataset and draw inferences on the sentiment in a way that is time efficient or effective.

FIG. 2 is a block diagram 200 illustrating a sentiment analysis platform 210, according to one or more aspects of the present disclosure. The techniques described in relation to the sentiment analysis platform 210 are described in relation to sentiment analysis on natural language sentences for downstream enterprise remediation and improved customer experience. The sentiment analysis platform 210 shares similar features and elements described above with respect to the computing device 110 of FIG. 1. The similar elements in sentiment analysis platform 210 therefore may share description as the corresponding element or component described in relation to FIG. 1, and as a result, the description references prior discussion of similar functionality.

As shown in FIG. 2, the sentiment analysis platform 210 includes data processing 212 (i.e., similar to data processing 114 of FIG. 1), deep learning model(s) 214 (i.e., similar to deep learning models 116 of FIG. 1), model training 216, and model inference 218. Sentiment analysis platform 210 receives input data 202 as input. Input data 202 can comprise training data, such as the training dataset described with respect to FIG. 1. Input data 202 can also comprise inference data such as the inference dataset described with respect to FIG. 1. As previously mentioned, the inference dataset can comprise user reviews received from client devices 130A-130N. In other words, each client device of client devices 130A-130N may be associated with a particular user who has provided a review, feedback, or information to an enterprise. Each of these reviews, feedback, or information may be received over network 140 by sentiment analysis platform 210. The inference dataset may refer to unlabeled user data that an enterprise wishes to perform sentiment analysis on to determine a sentiment of each element (e.g., a positive sentiment label, a negative sentiment label, a neutral sentiment label, and so on). The enterprise may evaluate the inference dataset to identify areas within the enterprise where users are experiencing frustrations, technical issues, etc. that require remediation.

Sentiment analysis platform 210 includes data processing 212. Data processing 212 can receive input data 202 as input and perform pre-processing operations on the input data 202 to otherwise prepare the input data 202 for sentiment analysis performed by deep learning model(s) 214. As described above with respect to FIG. 1, and as described in more detail with respect to FIG. 4, data processing 212 can tokenize input data 202 into individual tokens, parse the individual tokens to extract the linguistic structures and relationships within text data of the individual tokens, and then convert the parsed data into string diagram format. Once in string diagram format, data processing 212 can perform additional steps to normalize the string diagrams and then convert the string diagrams into an embedded representation. In the context of ML for sentiment analysis, embedded representations can refer to numerical representations of the semantic features associated with the input data 202. Furthermore, and as described with respect to FIG. 1, sentiment analysis platform 210 is configured to perform sentiment analysis on multiple forms of embedded representations. For instance, in the case where a quantum ML model is deployed and/or allocated by deep learning models 214, the embedded representation can be a tensor ansatz embedded representation. In the case of classical ML processes, the embedded representation can be a tensor representation. One of ordinary skill in the art would recognize many variations, modifications, and alternatives.

The sentiment analysis platform 210 also includes deep learning model(s) 214. Deep learning model(s) 214 can include the appropriate software and circuitry to enable classical deep learning models and/or quantum deep learning models to perform sentiment analysis on the input data 202. For instance, the deep learning models 214 can include classical computing circuitry to enable deployment and/or allocation of classical ML models. As described with respect to FIG. 1, the classical ML models may be classical ML models of any suitable type for performing sentiment analysis. For instance, the classical ML models that are part of deep learning model(s) 214 can include CNNs, RNNs, LSTMs, DIET models, BERT based models, GPT models, MLPs, autoencoders, and so on. Additionally, deep learning models 214 can include quantum computing circuitry to enable deployment and/or allocation of quantum ML models. As described with respect to FIG. 1, the classical ML models may be classical ML models of any suitable type for performing sentiment analysis. For instance, the classical ML models that are part of deep learning model(s) 214 can include QSVMs, QNNs, QPCAs, QVCs, and so on. In each case of classical ML models or quantum ML models including the listed versions as wells as future versions of any of these or other models usable for ML classification tasks.

In the case of model training and optimization, model training 216 may be employed by sentiment analysis platform 210 to train and fine-tune the deep learning model(s) 214 for sentiment analysis. As described with respect to FIG. 1, model training involves providing the training dataset to the respective ML model (quantum ML, classical ML, or otherwise) where the training dataset comprises a list of natural language sentiments with predefined sentiment labels. During the training phase, model training 216 can optimize performance of the deep learning model 214 via evaluating the output generated by the deep learning model 116 (i.e., the predicted sentiment label) against the true sentiment label (e.g., the sentiment label included in the training dataset). In other words, each predicted sentiment label generated by the deep learning model(s) 214 may be associated with a probability value representing the likelihood that the natural language sentence belongs to a particular class (e.g., the positive sentiment class). Then, a loss function may be applied for each predicted probability value. For instance, and according to one particular example, a binary cross entropy loss function may be used, where the binary cross entropy loss function quantifies the difference between the true sentiment labels and the predicted probabilities. During model optimization of model training 216, the loss function may be minimized by adjusting one or more parameters of the deep learning model 116 (e.g., updating the weights) to improve the predicted probability accuracies using gradient descent techniques as described with respect to FIG. 1. Training the deep learning model(s) 214 may be an iterative process where each training phase generates a new instance of a fine-tuned deep-learning model trained for the particular task of sentiment analysis.

Additionally, the deep learning model(s) 214 may be trained using model training 216 using a preconfigured dataset of specially curated training data. For instance, in the case of a financial institution, the input data 202 may correspond to customer reviews, feedback, etc. related to their experience banking with the financial institution. In this case, the input data 202 may include common words that are particularly relevant in the financial industry (checking, savings, credit, debit, loan, etc.). Training the deep learning model(s) 214 on training datasets that include these contextual words enables fine-tuning of the deep learning models for the domain specific task of the enterprise to thereby improve the accuracy of the deep learning model(s) 214 predictive classification capabilities.

After model training 216, sentiment analysis platform 210 can perform model inference 218 on the inference dataset of input data 202 to generate predicted sentiments 220. For instance, model inference 218, which utilizes one or more fine-tuned deep learning model(s) 214, can classify input data 202 as belonging to a positive sentiment class, a negative sentiment class, a neutral sentiment class, and so on. The predicted sentiments may then be used by the enterprise to identifies areas within the enterprise in need of remediation and/or improvement.

In one example, additional analysis may be performed by sentiment analysis platform 210 after model inference. In this example, after model inference 218 generates predicted sentiments 220, sentiment analysis platform 210 (or another computing device, such as computing device 110) may perform clustering of the all the input data 202 elements predicted to be in the negative sentiment class. Clustering may be performed to group the negative sentiment predicted data elements into further categories describing which parts of the enterprise the input data 202 relates to. For instance, in the case of a financial enterprise, clustering can involve drawing categories such as mortgages, loans, account information, problems with mobile applications, etc. Various techniques for clustering the predicted sentiments 220 can include clustering algorithms such as k-means clustering, Density-Based Spatial Clustering of Applications with Noise (“DBSCAN”), hierarchical DBSCAN (“HDBSCAN”), spectral clustering, Gaussian Mixture Models (“GMM”), and so on. Clusters with more data elements can represent areas where customers of the enterprise most frequently run into issues.

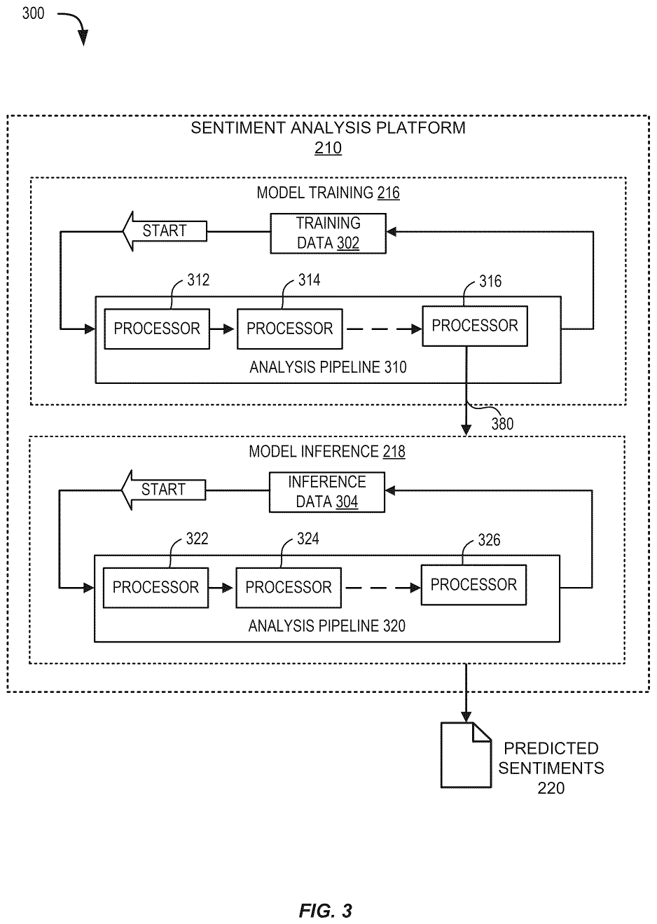

FIG. 3 is a block diagram 300 illustrating an example analysis pipeline of the sentiment analysis platform 210 of FIG. 2, according to one or more aspects of the present disclosure. As shown in FIG. 3, during model training 216, training data 302 (which may be a subset of input data 202) may be added to model training 216. Upon receipt of the training data 302 at model training 216 of sentiment analysis platform 210, analysis pipeline 310 processes the training data 302. In the example analysis pipeline of FIG. 3, the analysis pipeline 310 can include multiple processors 312 and 314 to process the training data 302. For example, processor 312 may perform one or more operations associated with data processing 212, including the various components included within data processing 212 (e.g., the tokenizer, parser, etc.) processor 314 may provide the one or more processors needed to deploy and/or allocate one or more deep learning models 214, and so on. Other operations, such as the operations described with respect to model optimization, for example, may be performed by one of the processors 312 or 314, or the other operations may be performed by additional processors (not illustrated) of the analysis pipeline 310.

After performing the operations related to model training 216, the model training 216 block may generate a fine-tuned instance of a deep learning model 380 operable for sentiment analysis on the inference dataset. As shown in FIG. 3, the fine-tuned instance of the deep learning model 380 may then be provided or otherwise be accessible by the model inference 218 of the sentiment analysis platform 210. Similar to the analysis pipeline 310 described with respect to the model training 216 portion, analysis pipeline 320 of model inference 218 can first receive the inference data 304 as input. Upon receipt of the inference data 304 at model inference 218 of sentiment analysis platform 210, analysis pipeline 320 processes the inference data 304. In the example shown in FIG. 3, analysis pipeline 320 includes additional processors such as processor 322, 324, and 326 to perform the various operations described above with respect to FIGS. 1 and 2 (i.e., tokenization, parsing, string diagram conversion, embedding, sentiment prediction, etc.) However, in some examples, and to save computational resources, analysis pipeline 320 can utilize the same processors as analysis pipeline 310 (i.e., processor 312, 314, 316, and so on) to perform pre-processing operations. After each data element from the inference data 304 is processed, the model inference 218 outputs respective predictive sentiments 220 indicated a predicted class label for each of the inference data 304. As described with respect to FIG. 2, the predicted sentiments 220 may undergo further processing (e.g., clustering, etc.) and/or may be used by an enterprise to better understand the sentiment and feedback of their customers.

FIG. 4 is a block diagram illustrating an example data flow 400 for a sentiment analysis platform 210 that provides sentiment analysis on input data using one or more deep learning models 214. The sentiment analysis platform 210 in this example has been configured to receive input data in the form of training data 302 and inference data 304. Training data 302 and inference data 304 may collectively be referred to as input data and is similar to input data 202 described with respect to FIG. 2. As previously described in relation to FIG. 3, training data 302 can include natural language sentences associated with user reviews, feedback, survey responses, etc. each of which including a predefined sentiment label (e.g., positive, negative, neutral, etc.). The training data 302 can be utilized to train and fine-tune one or more instances of the deep learning models 214. Additionally, the inference data 304 can include natural language sentences associated with user reviews, feedback, survey responses, etc. However, each of the data elements in the inference data 304 may not have a corresponding sentiment label. Instead, sentimental analysis platform 210 can perform sentiment analysis on the inference data 304 to predict a corresponding sentiment label for each data element in the inference data 304.

As previously mentioned with respect to FIG. 2, sentiment analysis platform 210 can include data processing 212 and deep learning models 214. Included within data processing 212 can be tokenizer 402, parser 404, and embedder 440 (collectively “pre-processing tools”). Each of the pre-processing tools included in data processing 212 may be configured to perform operations on the training data 302 or inference data 304 to otherwise prepare the input data for processing by deep learning models 214.

Tokenizer 402 may first tokenize the input data. Tokenization refers to deconstructing the natural language sentences of the input data into individual tokens where each token represents a single sentence of the various natural language sentences included in the training dataset. Tokenization of the input data is an important step performed by data processing 212 to transform the raw text of the input data into a structured format. In addition, tokenization can also organize the input data (e.g., manage the variability of the input data) by standardizing the text by handling punctuation, case sensitivity, and special characters thereby making the text more uniform for future processing steps.

After tokenization, the input data may be provided to parser 404. Parsing the individual tokens may refer to the process of extracting linguistic structures and relationships within the text data of the input data. In other words, parsing the tokenized data may refer to the process of breaking down the natural language sentences of each token into their constituent parts (e.g., words, phrases, clauses) and identifying syntactic relationships between the constituent parts. Parsing the tokens enables a deeper understanding of natural language sentence composition which improves feature extraction, ambiguities identification, and model accuracy at future processing steps.

Once the tokenized input data has been parsed, the input data is provided to embedder 440 where the natural language sentences are converted into an embedded form. The embedded form may refer to an abstract representation of the natural language sentences of the input data reflecting the syntactic relationships between the constituent parts. A first step performed by embedder 440 can include transforming the parsed and tokenized natural language sentences into string diagram representations. As previously mentioned with respect to FIGS. 1-3, string diagrams represent the linguistic relationships extracted from the parser in a graphical form that is amenable for both classical and quantum processing. More specifically, the string diagram representation expresses computations in a monoidal category, which is an abstract well-suited to model the functionality of ML models, and in particular quantum ML processes. After the string diagrams are generated, the string diagrams may be converted to either a classical embedded representation (i.e., classical representations 408) or a quantum embedded representation (i.e., quantum representations 410). As described with respect to FIG. 1, the embedded format may refer to a numerical representation of the string diagram format. For instance, one form of embedded representation which is amenable for quantum ML processes is to convert the string diagrams into a tensor ansatz embedded representation. As another example embedded format, the string diagrams may be converted to a tensor representation, which is amenable for classical ML processes. The inventors have determined that deep learning models trained to perform sentiment analysis on natural language sentences perform with higher accuracy when inferring sentiment predictions on embedded representations (e.g., tensor ansatz, tensor diagrams, or otherwise) of string diagrams. Thus, conversion to string diagrams before embedding can outperform conventional classical ML models performing classification tasks on embeddings that did not utilize string diagram representations.

Each of the classical representations 408 and quantum representations 410 may next be provided to deep learning models 214. Deep learning models 214 is configured with suitable hardware to perform classical ML tasks via classical computing circuitry 412 having one or more classical ML model(s) 414. Deep learning models 214 is also configured with suitable hardware to perform quantum ML tasks via quantum computing circuitry 416 having one or more quantum ML model(s) 418. The classical ML model(s) 414, which as previously mentioned can include CNNs, RNNs, LSTMs, DIET modes, BERT model, GPT models, MLPs, autoencoders, and so on (including future versions of any of these or other ML models), and the quantum ML model(s), which as previously mentioned can include QSVMs, QNNs, QPCAs, QVCs, and so on (including future versions of any of these or other ML models) can be specifically trained (using training data 302) to perform sentiment analysis on the inference data 304.

Also included in sentiment analysis platform 210 can be analysis engine 460. Analysis engine 460 can include clustering algorithm(s) 462. As described with respect to FIG. 2, sentiment analysis platform 210 may perform further analysis on the predicted sentiments 220 generated by deep learning models 214 (e.g., classical predicted sentiments 420 or quantum predicted sentiments 422) to further improve the accuracy and predicted results. In this example, clustering algorithm(s) 462 may apply a clustering algorithm on the predicted sentiments. More specifically, the clustering algorithm(s) 462 can cluster by topic all the input data predicted to be in the negative sentiment class. Using the clustering results, an enterprise can quickly identify which topics associated with the input data are receiving the most frequency negative sentiment reviews, for example. Various techniques for clustering the predicted sentiments can include clustering algorithms such as k-means clustering, Density-Based Spatial Clustering of Applications with Noise (“DBSCAN”), hierarchical DBSCAN (“HDBSCAN”), spectral clustering, Gaussian Mixture Models (“GMM”), and so on. Clusters with more data elements can represent areas where customers of the enterprise most frequently run into issues

Analysis engine 460 also includes model optimization 464. As described with respect to FIG. 2, model optimization 464 may utilize a loss function to optimize the performance of the classical ML model(s) 414 and/or the quantum ML model(s) 418 during the model training phase. For example. a binary cross entropy loss function may be used, where the binary cross entropy loss function quantifies the difference between the true sentiment labels and the predicted probabilities. The model optimization 464 may seek to minimize the binary cross entropy loss function by adjusting one or more parameters of the deep learning models 214 (e.g., weights) to improve the predicted probability accuracies, where adjusting one or more parameters includes using a gradient descent technique. After model training and optimization, deep learning models 214 may generate predicted sentiment labels (i.e., classical predicted sentiments 420 in the case of classical ML model(s) 414 or quantum predicted sentiments 422 in the case of quantum ML model(s) 418). The predicted sentiments generated by the deep learning models 214 can enable an enterprise to identify areas within the enterprise in need of remediation or improvement. The improved performance of the deep learning models, as described herein and above, such as utilizing string diagram representations, implemented quantum ML models, and so on, can reduce the likelihood of false positives and improve the accuracy in understanding the customer sentiments.

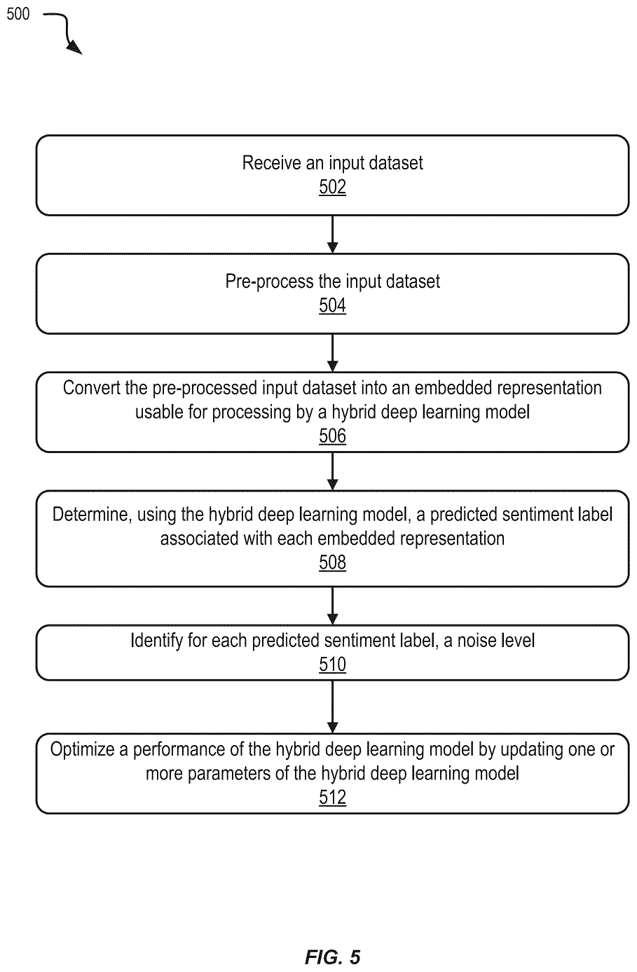

FIG. 5 is a flowchart of an example of a process 500 for training a hybrid deep learning model for sentiment analysis. The example process 500 will be described with respect to the sentiment analysis platform 210 of FIG. 2 and the example data flow 400 described with respect to FIG. 4; however, any suitable system or platform according to this disclosure may be employed, including the example computing platform 110 shown in FIG. 1. Additionally, process 500 is provided in the order shown, but other orders or additional steps may be provided.

At block 502, sentiment analysis platform 210 receives an input dataset (e.g., input data 202 comprising training data 302 and inference data 304). The input dataset can includes a plurality of natural language sentences. As previously mentioned with respect to FIG. 2-4, input data 202 may include training data 302 and inference data 304. The input dataset can be associated with user reviews, feedback, survey responses, etc. each of which, in the case of training data 302, includes a predefined sentiment label (e.g., positive, negative, neutral, etc.). The training data 302 of the input dataset can be utilized to train and fine-tune one or more instances of the deep learning models 214 to fine-tune the deep learning models 214 for the specific task of sentiment analysis during model inference on the unlabeled inference data 304.

At block 504, sentiment analysis platform 210 pre-processes the input dataset. Pre-processing the input dataset may include converting each natural language sentence into a string diagram representation. Although not illustrated by process 500, other pre-processing steps, such as those performed by data processing 212 described with respect to FIGS. 2-4, may be performed on the input dataset. This can include tokenization performed by tokenizer 402, parsing of the natural language sentences by parser 404, and embedding performed by embedder 440. As previously mentioned, the inventors have determined that combining a string diagram representation with sentiment analysis performed by deep learning models improves the accuracy of the predicted sentiment labels. In some examples, a dimensional reduction technique may be utilized to “rewrite” the string diagram representations to remove redundant words or uncover additional semantic relationships between the words in the natural language sentences. For instance, example techniques that may be utilized include term frequency (TF) analysis, term frequency inverse document frequency analysis (TF-IDF), principal component analysis (PCA), singular value decomposition (SVD), and so on.

At block 506, the pre-processed input dataset is converted into an embedded representation usable for processing by a hybrid deep learning model. For instance, in the case where the pre-processed input dataset comprises string diagram representations, each string diagram representation may be converted into an embedded representation usable for processing by the hybrid deep learning model. The embedded representation may refer to a numerical representation of the higher level abstraction associated with the string diagram representations. In some examples, the embedded representation can be tensor ansatz embedded representation, which is amenable for quantum ML processes performed by the hybrid deep learning model. In other examples, the string diagrams may be converted to a tensor representation, which is amenable for classical ML processes. Other classical or quantum embedded representations are possible such as feature vectors, word embeddings, angle encoding, and the like. As previously mentioned with respect to FIGS. 2-4, the inventors have determined that deep learning models trained to perform sentiment analysis on natural language sentences perform with higher accuracy when inferring sentiment predictions on embedded representations (e.g., tensor ansatz, tensor diagrams, or otherwise) of string diagrams. Thus, conversion to string diagrams before vector embedding can outperform conventional classical ML models performing classification tasks on embeddings that did not utilize string diagram representations.

At block 508, process 500 involves determining, using the hybrid deep learning model, a predicted sentiment label associated with each embedded representation. In some examples, each predicted sentiment label is associated with a respective probability that each natural language sentence belongs to a first class. In some examples, the first class may be associated with a positive sentiment class. In some examples, the hybrid deep learning model is implemented by classical computational circuitry to implement one or more classical ML models. As previously mentioned throughout the present disclosure, the one or more classical ML models can include CNNs, RNNs, LSTMs, DIET modes, BERT model, GPT models, MLPs, autoencoders, and so on including future versions of any of these or other classical ML models.

In some examples, the hybrid deep learning model is implemented by quantum computing circuity to implement one or more quantum ML models. As previously mentioned throughout the present disclosure, the one or more quantum ML models can include QSVMs, QNNs, QPCAs, QVCs, and so on including future versions of any of these or other quantum ML models. In this example, process 500 can further include mapping the embedded representations (which in the case of quantum ML can be in a tensor ansatz representation format) to a plurality of quantum circuits. The quantum ML models of the hybrid deep learning model may utilize quantum bits (or “qubits”) to perform computations on the input dataset by manipulating (e.g., altering the sequence and configuration) of quantum gates within the quantum circuits. The quantum ML models of the hybrid deep learning model may output a probabilistic distribution of each input embedded representation where the most probable output is identified as the “correct” output.

At block 510, sentiment analysis platform 210 may identify a noise level associated with each predicted sentiment label generated by the hybrid deep learning model. As previously mentioned, the predicted sentiment labels may be associated with a generated probability value representing the likelihood that the natural language sentence belongs to a particular class (e.g., the positive sentiment class). A difference between the predicted probability and the true sentiment label of the natural language sentence may be referred to as the noise level for the predicted sentiment label. Thus, for each predicted sentiment label, a corresponding noise level may be computed.

At block 512, sentiment analysis platform 210 can optimize a performance of the hybrid deep learning model by updating one or more parameters (e.g., weights) of the respective hybrid deep learning model. This step can involve utilizing a loss function to identify the noise level and then updating the weights of the hybrid deep learning model to minimize the noise level. As mentioned with respect to FIG. 1, one example loss function can be a binary cross entropy loss function, where the binary cross entropy loss function quantifies the difference between the true sentiment labels and the predicted probabilities. Utilizing such a loss function improves the predicted probabilities of the hybrid deep learning model during each training iteration. After model optimization, a second, a third, or additional instance of a fine-tuned hybrid deep learning model (e.g., either one or more classical ML models or one or more quantum ML models) may be instantiated. The fine-tuned models can be further refined and trained using an iterative training process. Once trained for the specific purpose of sentiment analysis, the sentiment analysis platform 210, during model inference, may predict sentiment labels for the inference data 304 included in the input dataset. An enterprise may then leverage these predicted sentiment labels to identify areas within the enterprise in need of improvement or remediation. The techniques described by process 500 as performed by sentiment analysis platform 210 greatly improve the efficiency of sentiment analysis performed by an enterprise that would not be possible otherwise. For instance, a large enterprise may have hundreds of thousands of touch points with customers every single day that may result in an equivalent number of feedback responses. Such feedback requires extensive review to determine areas within the enterprise where the enterprise could improve its performance to provide for a better customer experience. Using the techniques described herein, an enterprise can quickly identify problem areas and quickly work to identify solutions to such problems in ways that would not have been possible through manual review.

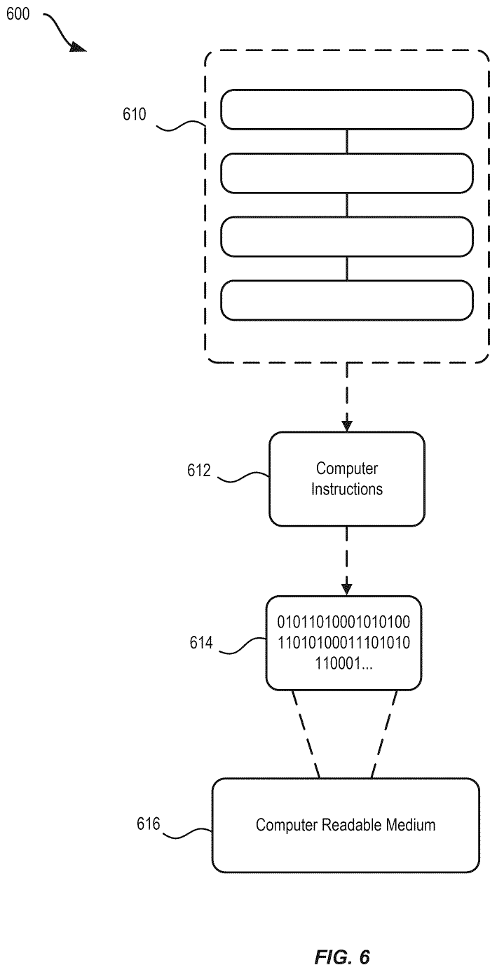

One or more of the aspects of the present disclosure include a computer-readable medium including microprocessor or processor-executable instructions configured to implement one or more embodiments presented herein. FIG. 6 is a block diagram illustrating an example computer-readable medium or computer-readable device including processor-executable instructions configured to embody one or more of the aspects set forth herein. As illustrated in FIG. 6, implementation 600 includes a computer-readable medium 616. Computer-readable medium 616 can include a CD-R, DVD-R, flash drive, a platter of a hard disk drive, and so forth, on which computer-readable data 614 is encoded and stored. The computer-readable data 614, such as binary data including a plurality of zero's and one's as illustrated, in turn includes a set of computer instructions 612 configured to operate according to one or more of the principles set forth herein.

In the illustrated implementation 600 of FIG. 6, the set of computer instructions 612 (e.g., processor-executable computer instructions) may be configured to perform a method 610, such as the process 500 of FIG. 5, for example. In another embodiment, the set of computer instructions 612 may be configured to implement a system, such as computing platform 110 of FIG. 1 or the sentiment analysis platform 210 of FIG. 2, FIG. 3, and FIG. 4, for example. Many such computer-readable media may be devised by those of ordinary skill in the art that are configured to operate in accordance with the techniques presented herein.

As used in this application, the terms “component,” “module,” “system,” “interface,” “manager,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

A device may also be called and may contain some or all of the functionality of a system, subscriber unit, subscriber station, mobile station, mobile, mobile device, wireless terminal, device, remote station, remote terminal, access terminal, user terminal, terminal, wireless communication device, wireless communication apparatus, user agent, user device, or user equipment (UE). A mobile device may be a cellular telephone, a cordless telephone, a Session Initiation Protocol (SIP) phone, a smart phone, a feature phone, a wireless local loop (WALL) station, a personal digital assistant (PDA), a laptop, a handheld communication device, a handheld computing device, a netbook, a tablet, a satellite radio, a data card, a wireless modem card, and/or another processing device for communicating over a wireless system. Further, although discussed with respect to wireless devices, the disclosed aspects may also be implemented with wired devices, or with both wired and wireless devices.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

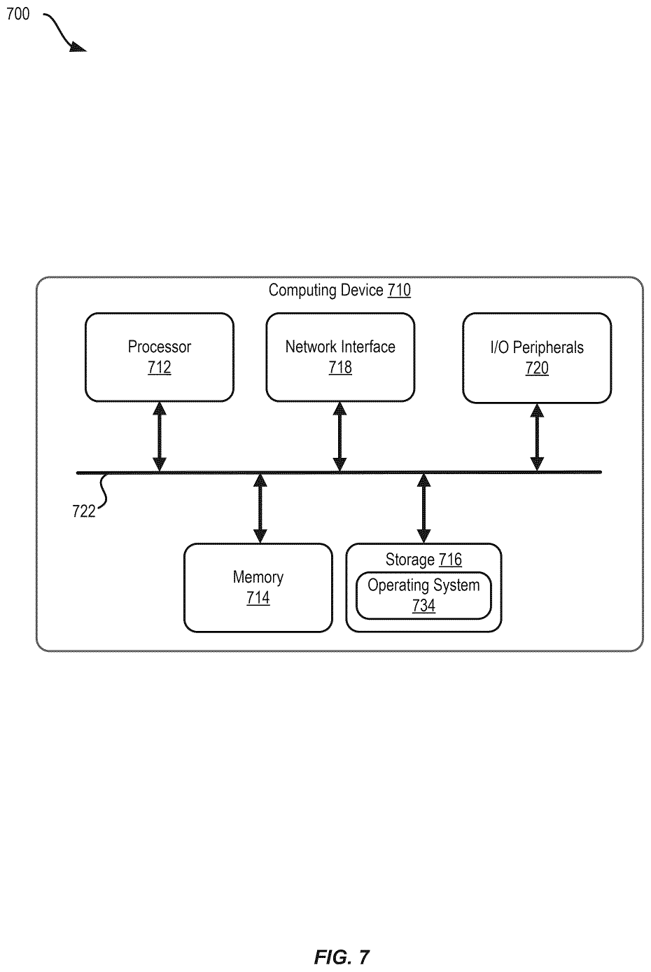

FIG. 7 and the following discussion provide a description of a suitable computing environment 700 to implement embodiments of one or more aspects of the present disclosure. The computing environment 700 of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, application programming interfaces (APIs), data structures, and the like, which perform one or more tasks or implement one or more abstract data types. Typically, the functionality of the computer readable instructions is combined or distributed as desired in various environments.

FIG. 7 is a block diagram illustrating an example computing environment 700 for implementing a hybrid deep learning model for sentiment analysis, according to one or more aspects of the present disclosure. In one configuration, the computing device 710 may include at least one processor 712 and at least one memory 714. Depending on the exact configuration and type of computing device, the at least one memory 714 may be volatile, such as RAM, non-volatile, such as ROM, flash memory, etc., or a combination thereof. Examples of processor 712 include a microprocessor, an application-specific integrated circuit (ASIC), a field-programmable gate array (FPGA), or any other suitable processing device. Computing device 710 can include one processor, such as is illustrated by processor 712 in FIG. 7, or more than one processor.

Computing device 710 may include additional features or functionality. For example, the computing device 710 may include storage such as removable storage or non-removable storage, including, but not limited to, magnetic storage, optical storage, etc. Such storage is illustrated in FIG. 7 by storage 716. In one or more embodiments, computer readable instructions to implement one or more embodiments provided herein are in the storage 716. The storage 716 may store other computer readable instructions to implement an operating system, an application program, etc. Computer readable instructions may be loaded in the at least one memory 714 for execution by the at least one processor 712, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 7, the computing environment 700 may also include a number of additional external or internal devices, for example, input or output devices. For example, computing device 710 is illustrated as including input/output (I/O) peripherals 720. I/O peripherals 720 can receive input from an input device (not shown) or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device 710.

I/O peripherals 720 may be connected to the computing device 710 via a wired connection, wireless connection, or any combination thereof. Further, the computing device 710 may include network interface 718 to facilitate communications with one or more other devices (not shown). Network interface 718 can include any device or group of devices suitable for establishing a wired or wireless data connection to one or more data networks. Non-limiting examples of the network interface 718 include an Ethernet network adaptor, a wireless network adapter, a modem, Wi-Fi adapter, Bluetooth adapter, near field communication (NFC) receiver and transmitter, and any other known wired or wireless data transmission system.

Computing device 710 also includes interface bus 722. Although only one interface bus is illustrated, computing environment 700 can include more than one interface bus. Interface bus 722 can communicatively couple one or more components of computing device 710. Computing environment 700 also includes one or more programs and/or program data that may be accessible in storage 716 by the computing device 710. For example, storage 716 can store an operating system 734 utilized to control the operation of the computing device 710. Storage 716 can also store other system application programs and data utilized by the computing device 710, such as modules implementing the functionalities provided by the computing device 110 or the sentiment analysis platform 210 or any other functionalities described above with respect to FIGS. 1-4. The storage 716 may also store other programs and data not specifically identified herein.

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method of training a hybrid deep learning model for sentiment analysis, the method comprising:
receiving an input dataset comprising a plurality of natural language sentences and a plurality of sentiment labels, wherein each natural language sentence is associated with a respective sentiment label;
pre-processing the input dataset to convert each natural language sentence into a string diagram representation to thereby generate a plurality of string diagrams;
converting each of the plurality of string diagrams into a plurality of embedded representations usable for processing by a hybrid deep learning model;
determining, using the hybrid deep learning model, a predicted sentiment label associated with each embedded representation to thereby generate a plurality predicted sentiment labels, wherein each predicted sentiment label is associated with a respective probability that each natural language sentence belongs to a first class;
identifying for each predicted sentiment label, a noise level; and
optimizing a performance of the hybrid deep learning model by updating one or more parameters of the hybrid deep learning model.

2. The method of claim 1, wherein the plurality of embedded representations comprises a plurality of tensor representations and wherein the hybrid deep learning model is implemented by classical computational circuitry.

3. The method of claim 1, wherein the plurality of embedded representations comprises a plurality of tensor ansatz representations, wherein the hybrid deep learning model is implemented by quantum computing circuity, and wherein the method further comprises:
mapping the plurality of tensor ansatz representations to a plurality of quantum circuits for use by the quantum computing circuitry.

4. The method of claim 1, wherein the hybrid deep learning model comprises one or more quantum machine learning algorithms implemented by quantum computing circuitry.

5. The method of claim 1, wherein identifying the noise level comprises evaluating each respective probability using a binary cross entropy loss function, and wherein optimizing the hybrid deep learning model comprises minimizing the binary cross entropy loss function.

6. The method of claim 1, wherein prior to receiving the input dataset, the hybrid deep learning model is generated by fine-tuning a first instance of a pre-trained deep learning model.

7. The method of claim 6, wherein optimizing the performance of the hybrid deep learning model further comprises:
generating, based on updating the one or more parameters, a second instance of the hybrid deep learning model, wherein the one or more parameters are associated with one or more weights of the hybrid deep learning model; and
fine-tuning the second instance of the hybrid deep learning model.

8. The method of claim 1, wherein the plurality of sentiment labels comprises a first sentiment label associated with a positive class and a second sentiment label associated with a negative class.

9. The method of claim 1, further comprising:
performing a dimensional reduction technique on each of the plurality of string diagrams based on one or more redundant semantic features associated with each of the plurality of string diagrams.

10. The method of claim 1, further comprising:
receiving, after updating one or more parameters of the hybrid deep learning model, a second input dataset, wherein the second input dataset comprises a plurality of unlabeled customer reviews; and
performing sentiment analysis on the second input dataset using the hybrid deep learning model including updates to the one or more parameters.

11. A system for training a hybrid deep learning model for sentiment analysis comprising:
one or more processors;
a memory coupled to the one or more processors, the memory including instructions that, when executed by the one or more processors, cause the one or more processors to:
receive an input dataset comprising a plurality of natural language sentences and a plurality of sentiment labels, wherein each natural language sentence is associated with a respective sentiment label;
pre-process the input dataset to convert each natural language sentence into a string diagram representation to thereby generate a plurality of string diagrams;
convert each of the plurality of string diagrams into a plurality of embedded representations usable for processing by a hybrid deep learning model;
determine, using the hybrid deep learning model, a predicted sentiment label associated with each embedded representation to thereby generate a plurality predicted sentiment labels, wherein each predicted sentiment label is associated with a respective probability that each natural language sentence belongs to a first class;
identify for each predicted sentiment label, a noise level; and
optimize a performance of the hybrid deep learning model by updating one or more parameters of the hybrid deep learning model.

12. The system of claim 11, wherein the plurality of embedded representations comprises a plurality of tensor representations and wherein the hybrid deep learning model is implemented by classical computational circuitry.

13. The system of claim 11, wherein the plurality of embedded representations comprises a plurality of tensor ansatz representations, wherein the hybrid deep learning model is implemented by quantum computing circuity, and wherein the instructions further cause the one or more processors to:
map the plurality of tensor ansatz representations to a plurality of quantum circuits for use by the quantum computing circuitry.

14. The system of claim 11, wherein the hybrid deep learning model comprises one or more quantum machine learning algorithms implemented by quantum computing circuitry, and wherein identifying the noise level comprises evaluating each respective probability using a binary cross entropy loss function, and wherein optimizing the hybrid deep learning model comprises minimizing the binary cross entropy loss function.

15. The system of claim 11, wherein prior to receiving the input dataset, the hybrid deep learning model is generated by fine-tuning a first instance of a pre-trained deep learning model.

16. The system of claim 15, wherein the instructions further cause the one or more processors to:
generate, based on updating the one or more parameters, a second instance of the hybrid deep learning model, wherein the one or more parameters are associated with one or more weights of the hybrid deep learning model; and
fine-tune the second instance of the hybrid deep learning model.

17. The system of claim 11, wherein the plurality of sentiment labels comprises a first sentiment label associated with a positive class and a second sentiment label associated with a negative class.

18. The system of claim 11, wherein the instructions further cause the one or more processors to:
perform a dimensional reduction technique on each of the plurality of string diagrams based on one or more redundant semantic features associated with each of the plurality of string diagrams.

19. The system of claim 11, wherein the instructions further cause the one or more processors to:
receive, after updating one or more parameters of the hybrid deep learning model, a second input dataset, wherein the second input dataset comprises a plurality of unlabeled customer reviews; and
perform sentiment analysis on the second input dataset using the hybrid deep learning model including updates to the one or more parameters.

20. A non-transitory computer-readable medium embodying program code that is executable by one or more processors to cause the one or more processors to:
receive an input dataset comprising a plurality of natural language sentences and a plurality of sentiment labels, wherein each natural language sentence is associated with a respective sentiment label;
pre-process the input dataset to convert each natural language sentence into a string diagram representation to thereby generate a plurality of string diagrams;
convert each of the plurality of string diagrams into a plurality of embedded representations usable for processing by a hybrid deep learning model;
determine, using the hybrid deep learning model, a predicted sentiment label associated with each embedded representation to thereby generate a plurality predicted sentiment labels, wherein each predicted sentiment label is associated with a respective probability that each natural language sentence belongs to a first class;
identify for each predicted sentiment label, a noise level; and
optimize a performance of the hybrid deep learning model by updating one or more parameters of the hybrid deep learning model.
